(19) United States
(12) Patent Application Publication
(10) Pub. No.: US 2015/0041722 A1
(43) Pub. Date: Feb. 12, 2015

(54) Process For Purifying Tail Gas From Ore-Smelting Electrical Furnace by Catalytic Oxidization

(71) Applicant: Kunming University of Science And Technology, Yunnan (CN)

(72) Inventors: Ping Ning, Yunnan (CN); Xueqian Wang, Yunnan (CN); Xiangyu Wang, Yunnan (CN); Senlin Tian, Yunnan (CN); Xiaolong Tang, Yunnan (CN); Huaping Gao, Yunnan (CN); Honghong Yi, Yunnan (CN)

(73) Assignee: Kunming University of Science and Technology, Yunman (CN)

(21) Appl. No.: 14/384,716

(22) PCT Filed: Mar. 12, 2012
(86) PCT No.: PCT/CN2012/072193

§ 371 Date: Sep. 12, 2014

(51) Int. Cl. C01B 3/58

(52) U.S. Cl. CPC C01B 3/58; C01B 2203/0435; C01B 2203/0415; C01B 2203/169
USPC 252/373

(57) ABSTRACT

Disclosed is a process for purifying tail gases from an ore-smelting electrical furnace by catalytic oxidization, which comprises: impregnating a catalyst carrier in an impregnating solution, then aging, calcinating, and finally drying, so as to prepare a catalyst of high efficiency; then washing the tail gases from an ore-smelting electrical furnace with an aqueous alkali-containing solution, pre-heating the alkali-washed tail gas; and adjusting the oxygen volume content in the tail gases, charging the tail gases at a certain speed, purifying the gases by a catalytic oxidization fixed bed containing the catalyst of high efficiency, cooling the purified gas, so as to obtain the feed gases for C1 chemistry.

### FIELD OF THE INVENTION

The present invention relates to a process for purifying the tail gases from an ore-smelting electrical furnace by catalytic oxidization.

### BACKGROUND OF THE INVENTION

C1 chemical products are important organic chemical raw materials. With the decreasing of petroleum resource and the increasing price of petroleum, the application of C1 chemical products as alternatives for petrochemicals has been expanded in terms of range and number, therefore C1 chemical products play a more and more important role in the economy of various countries. At present, C1 chemistry has become the focus of research and development in many countries all over the world. As new products, new techniques and new catalysts emerge endlessly, carbon monoxide has almost become a chemical raw material as important as basic petrochemical materials such as ethylene and propylene, etc. With the development of C1 chemistry technology, especially some achievements obtained in oxo-synthesis reactions of CO, it's possible to synthesis various organic compounds with great economic value from CO, including methyl formate, dimethyl ether, acetic acid, methanol and dimethyl carbonate, etc.

Industrial exhaust gases contain abundant CO and those originated from an ore-smelting electrical furnace are especially worth utilizing. If industrial exhaust gases from an ore-smelting electrical furnace are to be utilized, they should be purified first. For example, if the reductive tail gases from an ore-smelting electrical furnace, which contains 30˜90% CO, are to be used as the feed gases for producing C1 chemical products, CO with high purity must be obtained first. Obviously, the presence of impurities in the tail gases from an ore-smelting electrical furnace has greatly limited the effective utilization of the gas. Therefore, in order to obtain high quality products and to ensure the follow-up comprehensive utilization procedure goes well, the tail gases must be purified. Utilizing the tail gases from an ore-smelting electrical furnace as a raw material for producing C1 chemical products can change the current situation that the production with ore-melting electrical furnaces, which lacks of competitiveness in the market due to high production cost, and achieve goals such as energy saving, pollutant emission cutting, energy consumption reducing as well as cleaner production. However, so far, the precious resource like the tail gases from an ore-smelting electrical furnace being rich in CO, its application is confined to drying feedstocks, and most of it is just burnt and emitted. The limiting factor for using the tail gases from an ore-smelting electrical furnace is the impurities therein, which have adverse effect on oxo-synthesis reactions, i.e. the problem of purifying the tail gases from an ore-smelting electrical furnace has not been solved, and especially, the removal of phosphorus in the tail gases has a serious effect on the catalyst for oxo-synthesis of CO.

As ores are reduced at high temperature in an ore-smelting electrical furnace, the impurities in the tail gases are mainly in their reduced state. For example, phosphorus exists in elemental phosphorus (P₄) and phosphine (PH₃), sulfur exists in hydrogen sulfide (H₂S) and organic sulfur, and fluorine exists in hydrogen fluorine (HF) and silicon fluoride (SiF₄), etc. Two methods have been primarily used in the prior art for purifying the tail gases, which are water-washing method and alkali-washing method:

1. Water-washing: the reductive exhaust gases are cooled and the dust therein is removed, and meanwhile, fluoride, some of the elemental phosphorus, phosphine, hydrogen fluoride and hydrogen sulfide are also removed therefrom. Because the vapor pressure of phosphorus deceases rapidly with decrease of temperature, some of the phosphorus in tail gases can be removed due to condensation, and meanwhile, some hydrogen sulfide can also be removed due to its dissolving in water.

2. Alkali-washing: plenty of acidic gases such as carbon dioxide (CO₂), hydrogen sulfide, hydrogen fluorine are removed by means of chemical reaction using a 0.8˜10% sodium hydroxide solution (NaOH).

The main shortages of the above mentioned methods are: low efficiency and incomplete removal of the elemental substances, catalyst poisoning in various catalytic reactions, and incapability of meeting the requirements as a raw material for C1 chemistry.

### DESCRIPTION OF THE INVENTION

The present invention overcomes the shortages of the prior art, aiming to solve the problem in purification pretreatment of the tail gases from an ore-smelting electrical furnace, and provide a process for purifying the tail gases from an ore-smelting electrical furnace by catalytic oxidization. After the tail gases are purified by the process according to the present invention, the typical impurities therein such as sulfur, phosphorus and fluorine are less than 1 mg/m³ respectively, which makes the tail gases meet the requirements for being used as the feed gases for producing high-value-added C1 chemical products.

The tail gases from an ore-smelting electrical furnace are reductive industrial exhaust gases, mainly comprising: CO 85˜95% (V/V), CO₂ 3˜% (V/V), H₂ 1˜8% (V/V), N₂ 2˜5% (V/V), O₂ 0.2˜1% (V/V), total phosphorus 1000˜5000 mg/m³, H₂5 1000˜5000mg/m³ and HF 300˜4000 mg/m³.

The typical impurities of elemental substances that are present in the tail gases from an ore-smelting electrical furnace can be removed by means of alkali-washing of the gas, and the aerosol of the typical impurities of elemental substances can be converted into gas, which facilitates the removal by catalytic oxidation purification methods subsequently; the alkali-washed tail-gases are pre-heated and pass through a catalytic oxidization fixed-bed, the typical gaseous impurities can be oxidized on the surface of the catalyst by the trace oxygen in the tail gases and be removed.

The impurities such as silicon fluoride, carbon dioxide and partial elemental phosphorus in the tail gases from an ore-smelting electrical furnace can be removed by the aqueous alkali solution, wherein, the chemical reactions are shown as follows:

P₄+3NaOH+3H₂O→3NaH₂PO₄+PH₃

3SiF₄+4H₂O=2H₂SiF₆+SiO₂·H₂O

CO₂+2NaOH=Na₂CO₃+H₂O

HF+NaOH=NaF+H₂O

NaOH is recovered by caustification of the washing liquid containing Na₂CO₃ and sent back to the system for recycling. After the above alkali-washing process, the tail gases still can't meet the requirements as the feed gases to produce chemical products. In order to further remove the impurities such as phosphide and sulfide, the present invention provides a process for further purifying the tail gases from an ore-smelting electrical furnace by catalytic oxidization on the basis of the alkali-washing process.

The alkali-washed tail gases are preheated through a pre-heater, and pass through a reactor from the bottom to the top. The reactor is loaded with catalyst of high efficiency, wherein the impurities such as elemental phosphorus, phosphine and hydrogen fluoride are catalytically oxidized. Herein, the catalytic oxidation reaction of sulfur is:

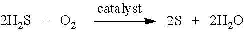

The catalytic oxidation reactions of elemental phosphorus are:

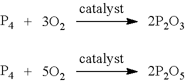

Since phosphine has a strong reductibility, oxidation-reduction reaction occurs between the low-valent P in the tail gases and the high-valent metal ions (Me³⁺), wherein P is oxidized into phosphoric acid and the metal ions (Me³⁺) is reduced, and then the reduced metal ions are oxidized by the O₂ in the gas, thereby the catalyst is recycled. The main chemical reactions mentioned above are shown as follows:

PH₃(g)+8Me³⁺(s)+4H₂O(l)=8Me²⁺ (aq)+H₃PO₄(aq)+8H⁺(aq)

O₂(g)+4Me²⁺(aq)+2H₂O(l)=4Me³⁺(s)+4OH⁻(aq)

The total reaction is:

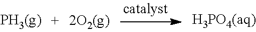

The catalytic oxidation reaction of fluoride is:

MeₙOₘ+HF→MeFₘ+H₂O

wherein MeₙOₘ is the metal oxide added in the catalyst.

The purified tail gases discharged from the reactor are cooled to less than 30° C. by cooling tower, and results in the qualified feed gases for Cl chemistry.

The concrete steps of the process are as follows:

(1) the catalyst carrier is impregnated with the impregnating solution for 10-24 h, then aged for 18-24 h, calcinated at 350˜650° C. for 6-12 h, and dried at 110° C. for 2-8 h to obtain the catalyst of high efficiency;

(2) the tail gases from an ore-smelting electrical furnace are washed with aqueous alkali solution, and the washed gases are pre-heated to 70˜110° C.;

(3) after the volume content of the oxygen in the tail gases from step (2) is adjusted to 0.5˜3%, the tail gases pass through a catalytic oxidization fixed-bed from the bottom to the top with a flow rate of 300˜600m³ (volume of gas)/m³(volume of catalyst)·h for the purification reaction, the reaction temperature is 50˜100° C., and the fixed-bed is loaded with the catalyst of high efficiency obtained from step (1), and then the purified gases are cooled to obtain the feed gases for C1 chemistry.

The catalyst carrier in step (1) is activated alumina, zeolite, activated carbon or diatomite.

The impregnating solution in step (1) is sodium hydroxide solution, potassium hydroxide solution, ferrous sulfate solution, lead chloride solution, aluminum nitrate solution, sodium carbonate solution, copper acetate solution or lanthanum nitrate solution, with a mass concentration of 0.25˜7%.

When the catalyst carrier is activated alumina, it is impregnated with 0.35 mass % lanthanum nitrate solution.

When the catalyst carrier is zeolite, it is impregnated with 0.4 mass % ferrous sulfate solution.

When the catalyst carrier is activated carbon, it is impregnated with 0.5 mass % potassium hydroxide solution.

When the catalyst carrier is activated carbon, it is impregnated with 0.5 mass % sodium hydroxide solution.

When the catalyst carrier is activated carbon, it is impregnated with 0.2 mass % copper acetate solution.

When the catalyst carrier is activated carbon, it is impregnated with 7 mass % sodium carbonate solution.

When the catalyst carrier is diatomite, it is impregnated with 0.55 mass % aluminum nitrate solution first, then impregnated with 0.25 mass % lead chloride solution.

The catalyst in the step (3) when deactivated is activated with hot air for 4˜8 h, so that the materials which are adsorbed but incompletely oxidized, such as elemental phosphorus, phosphine, phosphorous trioxide and hydrogen sulfide, are thoroughly oxidized, then the catalyst is activated with water vapor for 2˜4 h, washed with water, heated to 95˜110° C. with stream, and finally dried with hot air for 24˜48 h, resulting in the activated catalyst which can be used again.

A system comprising two parallel fixed beds may be adopted in the purification process of the present invention, wherein when one fixed bed is out of function and the catalyst thereof need to be reactivated, the other one can keep working. The regeneration time of the catalyst is ½˜⅓ of the time of purifying the tail gases from an ore-smelting electrical furnace by catalytic oxidization, therefore the system can work continuously.

In the present process, the typical impurities of elemental substances in the tail gases from an ore-smelting electrical furnace are first removed by means of alkali-washing of the gas, and the aerosols of the typical impurities of elemental substances are converted into gas. The alkali-washed tail-gases are pre-heated and pass through a catalytic oxidization fixed-bed, the typical gaseous impurities can be oxidized on the surface of the catalyst by the trace oxygen in the tail gases and be removed. After the tail gases from an ore-smelting electrical furnace are purified by the above method, the content of each typical impurity in the tail gases is less than 1 mg/m³. The catalyst used in the present invention can significantly improve the purification efficiency, and is easy to be reactivated, and its utilization rate is high. Additionally, the purification process of the present invention is simple, and the purification cost is low.

The main factors affecting the purification efficiency are the reaction temperature, the oxygen content and the flow rate of the tail gases. The influence rules are listed below:

(1) In the presence of catalyst, the oxidation reaction can occur at a lower temperature such as 50˜100° C. Raising the temperature is in favor of the improvement of purification efficiency. However, when the temperature is higher than 100° C., increasing the temperature does not improve the purification efficiency notably.

(2) The oxygen content in the tail gases from an ore-smelting electrical furnace is 0.5˜3%. The purification efficiency increases with the increase of oxygen content.

(3) When the gas flow rate is in the range of 300˜600 m³(volume of gas)/m³ (volume of catalyst)·h, the purification effect can be improved by decreasing the gas flow rate. However, when the flow rate drops to 300 m³(volume of gas)/m³(volume of catalyst)·h, the purification effect cannot be further significantly improved.

In the process of the present invention, the adsorption capacity of the catalyst for PH₃ is 12˜28%, for elemental phosphorus is 24˜56%, for hydrogen sulfide is 11˜25%, and for hydrogen fluoride is 10˜22%. The content of the typical impurities such as hydrogen sulfide, total phosphorus, and hydrogen fluoride in the purified tail gases from an ore-smelting electrical furnace is less than 1 mg/m³ respectively, which can meet the requirements of being as the feed gases for C1 chemistry.

As compared to the prior art, the present invention has the following advantages:

(1) The purification efficiency is high. The tail gases meet the requirements of being used as the feed gases for C1 chemistry after purification.

(2) The process is simple, and the catalyst is inexpensive and easy to be obtained.

(3) The catalyst is easy to be regenerated after poisoned or deactivated, and its catalytic activity remains almost unchanged even if it has been regenerated for many times. Besides, the catalyst has high utilization rate and the purification cost is reduced.

(4) By means of the measures such as adding extra oxygen to increase the oxygen content of the tail gases from an ore-smelting electrical furnace and increasing the temperature of the tail gases, the purification efficiency is increased greatly.

(5) The whole purification system is working at a positive pressure, which can ensure the safety of operation.

### DESCRIPTION OF THE DRAWING

FIG. 1 is the flow chart of the process according to the present invention.

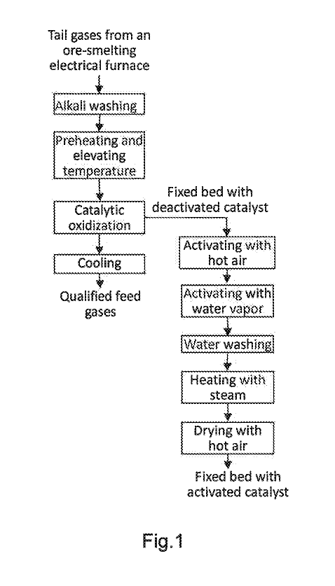

### EMBODIMENTS

The following examples are provided to further illustrate the invention, but not intended to limit the invention.

### Example 1

(1) The activated alumina is impregnated with a 0.25 mass % lanthanum nitrate solution for 20 h, then aged for 24 h, calcinated at 500° C. for 6 h in a muffle furnace, and finally dried at 110° C. for 4 h to obtain the catalyst of high efficiency.

(2) The tail gases from an ore-smelting electrical furnace are washed with a 0.8˜10 mass % aqueous solution of NaOH to remove phosphorus, and then the washed tail gases are preheated to 80° C.

(3) After the volume content of the oxygen in the tail gases from step (2) is adjusted to 0.5%, the tail gases pass through a catalytic oxidization fixed-bed from the bottom to the top with a flow rate of 500 m³(volume of gas)/m³(volume of catalyst)·for the purification reaction, and the fixed-bed is loaded with the catalyst of high efficiency obtained from step (1), the reaction temperature is 80° C., wherein, phosphine is catalytically oxidized, the oxidized products such as phosphorus pentoxide and phosphorus trioxide are adsorbed on the surface of the catalyst. Then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 4 h when it is deactivated, so that the materials which are adsorbed but incompletely oxidized, such as elemental phosphorus, phosphine, phosphorus trioxide and hydrogen sulfide, are thoroughly oxidized, then the catalyst is activated with water vapor for 2 h, washed with water, then heated to 110° C. with stream, and finally dried with hot air for 24 h, resulting in the activated catalyst which can be used again.

### Example 2

(1) The zeolite is impregnated with a 0.3 mass % ferrous sulfate solution for 24 h, then aged for 24 h, calcinated at 550° C. for 6 h, and finally dried at 110° C. for 4 h to obtain the catalyst of high efficiency.

(2) The tail gases from an ore-smelting electrical furnace are washed with aqueous alkali solution to remove carbon dioxide and some of phosphorus, sulfur and fluorine, and then the washed tail gases are preheated to 70° C.

(3) After the volume content of the oxygen in the tail gases from step (2) is adjusted to 0.5%, the tail gases pass through a catalytic oxidization fixed-bed from the bottom to the top with a flow rate of 500 m³(volume of gas)/m³(volume of catalyst)·for the purification reaction, and the fixed-bed is loaded with the catalyst of high efficiency obtained from step (1), the reaction temperature is 70° C., wherein, the impurities of phosphorus, sulfur is catalytically oxidized, the oxidized products such as phosphorus pentoxide, phosphorus trioxide, and sulfur are adsorbed on the surface of the catalyst. Then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 6 h when it is deactivated, so that the materials which are adsorbed but incompletely oxidized, such as elemental phosphorus, phosphine, phosphorus trioxide and hydrogen sulfide, are thoroughly oxidized, then the catalyst is activated with water vapor for 3 h, washed with water, then heated to 100° C. with stream, and finally dried with hot air for 32 h, resulting in the activated catalyst which can be used again.

### Example 3

(1) The activated carbon is impregnated with a 0.5 mass % potassium hydroxide solution for 18 h, then aged for 24 h, calcinated at 350° C. for 12 h, and finally dried at 110° C. for 6 h to obtain the catalyst of high efficiency.

(2) The tail gases from an ore-smelting electrical furnace are washed with aqueous alkali solution to remove carbon dioxide and some of phosphorus, sulfur and fluorine, and then the washed tail gases are preheated to 110° C.

(3) After the volume content of the oxygen in the tail gases from step (2) is adjusted to 0.5%, the tail gases pass through a catalytic oxidization fixed-bed from the bottom to the top with a flow rate of 600 m³(volume of gas)/m³(volume of catalyst)·for the purification reaction, and the fixed-bed is loaded with the catalyst of high efficiency obtained from step (1), the reaction temperature is 100° C., wherein, the impurities of phosphorus, sulfur is catalytically oxidized, the oxidized products such as phosphorus pentoxide, phosphorus trioxide, and sulfur are adsorbed on the surface of the catalyst. Then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 8 h when it is deactivated , so that the materials which are adsorbed but incompletely oxidized, such as elemental phosphorus, phosphine, phosphorus trioxide and hydrogen sulfide, are thoroughly oxidized, then the catalyst is activated with water vapor for 4 h, after that, washed with water, then heated to 110° C. with steam, and finally dried with hot air for 48 h, resulting in the activated catalyst which can be used again.

### Example 4

(1) The diatomite is impregnated with a 0.4 mass % aluminum nitrate solution for 20 h, then aged for 18 h, calcinated at 650° C. for 8 h, and finally dried at 110° C. for 2 h to obtain the catalyst of high efficiency.

(2) The tail gases from an ore-smelting electrical furnace are washed with aqueous alkali solution to remove carbon dioxide and some of phosphorus, sulfur and fluorine, and then the washed tail gases are preheated to 100° C.

(3) After the volume content of the oxygen in the tail gases from step (2) is adjusted to 0.5%, the tail gases pass through a catalytic oxidization fixed-bed from the bottom to the top with a flow rate of 400 m³ (volume of gas)/m³(volume of catalyst)·for the purification reaction, and the fixed-bed is loaded with the catalyst of high efficiency obtained from step (1), the reaction temperature is 50° C., wherein, the impurities of phosphorus, sulfur is catalytically oxidized, the oxidized products such as phosphorus pentoxide, phosphorus trioxide, and sulfur are adsorbed on the surface of the catalyst. Then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 5 h when it is deactivated, so that the materials which are adsorbed but incompletely oxidized, such as elemental phosphorus, phosphine, phosphorus trioxide and hydrogen sulfide are thoroughly oxidized, then the catalyst is activated with water vapor for 3.5 h, washed with water, then heated to 95° C. with stream, and finally dried with hot air for 40 h, resulting in the activated catalyst which can be used again.

### Example 5

(1) The activated carbon is impregnated with a 7 mass % sodium carbonate solution for 10 h, then aged for 20 h, calcinated at 450° C. for 10 h, and finally dried at 110° C. for 8 h to obtain the catalyst of high efficiency.

(2) The tail gases from an ore-smelting electrical furnace are washed with aqueous alkali solution, and then the washed tail gases are preheated to 90° C.

(3) After the volume content of the oxygen in the tail gases from step (2) is adjusted to 0.8%, the tail gases pass through a catalytic oxidization fixed-bed from the bottom to the top with a flow rate of 300 m³(volume of gas)/m³(volume of catalyst)·for the purification reaction, and the fixed-bed is loaded with the catalyst of high efficiency obtained from step (1), the reaction temperature is 100° C., then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 5 h when it is deactivated, so that the materials which are adsorbed but incompletely oxidized, such as elemental phosphorus, phosphine, phosphorus trioxide and hydrogen sulfide are thoroughly oxidized, then the catalyst is activated with water vapor for 3 h, washed with water, then heated to 100° C. with stream, and finally dried with hot air for 30 h, resulting in the activated catalyst which can be used again.

### Example 6

(1) The activated alumina is impregnated with a 0.35 mass % lanthanum nitrate solution for 14 h, then aged for 24 h, calcinated at 350° C. for 11 h, and finally dried at 110° C. for 8 h to obtain the catalyst of high efficiency.

(2) The tail gases from an ore-smelting electrical furnace are washed with aqueous alkali solution, and then the washed tail gases are preheated to 70° C.

(3) After the volume content of the oxygen in the tail gases from step (2) is adjusted to 3%, the tail gases pass through a catalytic oxidization fixed-bed from the bottom to the top with a flow rate of 400 m³(volume of gas)/m³(volume of catalyst)·for the purification reaction, and the fixed-bed is loaded with the catalyst of high efficiency obtained from step (1), the reaction temperature is 90° C., then the purified tail gases are cooled to obtain the feed gases for C1 chemistry. The content of the typical impurity such as phosphorus, sulfur and fluorine in the purified tail gases are less than 1 mg/m³ respectively.

### Example 7

(1) The zeolite is impregnated with a 0.4 mass % ferrous sulfate solution for 16 h, then aged for 18 h, calcined at 650° C. for 6 h, and finally dried at 110° C. for 3 h to obtain the catalyst of high efficiency.

(2) The tail gases from an ore-smelting electrical furnace are washed with aqueous alkali solution, and then the washed tail gases are preheated to 110° C.

(3) After the volume content of the oxygen in the tail gases from step (2) is adjusted to 1%, the tail gases pass through a catalytic oxidization fixed-bed from the bottom to the top with a flow rate of 500 m³(volume of gas)/m³(volume of catalyst)·for the purification reaction, and the fixed-bed is loaded with the catalyst of high efficiency obtained from step (1), the reaction temperature is 100° C., then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 5 h when it is deactivated, so that the materials which are adsorbed but incompletely oxidized, such as elemental phosphorus, phosphine, phosphorus trioxide and hydrogen sulfide are thoroughly oxidized, then the catalyst is activated with water vapor for 4 h, washed with water, then heated to 110° C. with stream, and finally dried with hot air for 28 h, resulting in the activated catalyst which can be used again.

### Example 8

(1) The activated carbon is impregnated with a 0.5 mass % sodium hydroxide solution for 22 h, then aged for 20 h, calcinated at 450° C. for 10 h, and finally dried at 110° C. for 5 h to obtain the catalyst of high efficiency.

(2) The tail gases from an ore-smelting electrical furnace are washed with aqueous alkali solution, and then the washed tail gases are preheated to 110° C.

(3) After the volume content of the oxygen in the tail gases from step (2) is adjusted to 2%, the tail gases pass through a catalytic oxidization fixed-bed from the bottom to the top with a flow rate of 400 m³(volume of gas)/m³(volume of catalyst)·for the purification reaction, and the fixed-bed is loaded with the catalyst of high efficiency obtained from step (1), the reaction temperature is 90° C., then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 8 h when it is deactivated, so that the materials which are adsorbed but incompletely oxidized, such as elemental phosphorus, phosphine, phosphorus trioxide and hydrogen sulfide are thoroughly oxidized, then the catalyst is activated with water vapor for 4 h, washed with water, then heated to 110° C. with stream, and finally dried with hot air for 48 h, resulting in the activated catalyst which can be used again.

### Example 9

(1) The activated carbon is impregnated with a 0.2 mass % copper acetate solution for 21 h, then aged for 24 h, calcinated at 650° C. for 12 h, and finally dried at 110° C. for 7 h to obtain the catalyst of high efficiency.

(2) The tail gases from an ore-smelting electrical furnace are washed with aqueous alkali solution, and then the washed tail gases are preheated to 110° C.

(3) After the volume content of the oxygen in the tail gases from step (2) is adjusted to 1.2%, the tail gases pass through a catalytic oxidization fixed-bed from the bottom to the top with a flow rate of 600 m³(volume of gas)/m³(volume of catalyst)·for the purification reaction, and the fixed-bed is loaded with the catalyst of high efficiency obtained from step (1), the reaction temperature is 100° C., then the purified tail gases are cooled to obtain the feed gases for C1 chemistry. The content of the typical impurity such as phosphorus, sulfur and fluorine in the purified tail gases are less than 1 mg/m³ respectively.

### Example 10

(1) The diatomite is first impregnated with a 0.55 mass % aluminum nitrate solution for 6 h, then impregnated with 0.25 mass % lead chloride solution for 10 h, then aged for 24 h, calcinated at 350° C. for 12 h, and finally dried at 110° C. for 4 h to obtain the catalyst of high efficiency.

(2) The tail gases from an ore-smelting electrical furnace are washed with aqueous alkali solution, and then the washed tail gases are preheated to 70° C.

(3) After the volume content of the oxygen in the tail gases from step (2) is adjusted to 2.5%, the tail gases pass through a catalytic oxidization fixed-bed from the bottom to the top with a flow rate of 600 m³(volume of gas)/m³(volume of catalyst)·for the purification reaction, and the fixed-bed is loaded with the catalyst of high efficiency obtained from step (1), the reaction temperature is 100° C., then the purified tail gases are cooled to obtain the feed gases for C1 chemistry. The content of the typical impurity such as phosphorus, sulfur and fluorine in the purified tail gases are less than 1 mg/m³ respectively.

In this embodiment, the catalyst of high efficiency is reactivated with hot air for 4 h when it is deactivated , so that the materials which are adsorbed but incompletely oxidized, such as elemental phosphorus, phosphine, phosphorus trioxide and hydrogen sulfide are thoroughly oxidized, then the catalyst is activated with water vapor for 4 h, after that, washed with water, then heated to 95° C. with stream, and finally dried with hot air for 48 h, resulting in the activated catalyst which can be used again.

1. A process for purifying tail gases from an ore-smelting furnace by catalytic oxidation comprising the following steps:
(1) impregnating a catalyst carrier with an impregnating solution for 10-24 hours, then aging for 18-24 [[h]]hours, calcinating at about 350-650° C. for 6-12 hours, and drying at 110° C. for 2-8 hours to obtain a catalyst of high efficiency;
(2) washing the tail gases from an ore-smelting electrical furnace with an aqueous alkali solution, and heating the washed gases to about 70-110° C.;
(3) adjusting a volume content of oxygen in the tail gases from step (2) to about 0.5 to 3%, then passing the tail gases through a catalytic oxidization fixed-bed from the bottom to the top of the fixed-bed with a flow rate of about 300-600 m³(volume of gas)/m³(volume of catalyst)·hour for at least one purification reaction, wherein the purification reaction occurs at about 50-100° C., thereby producing purified gases, and then loading the fixed-bed with the catalyst of high efficiency-obtained from step (1), and then cooling the purified gases to obtain feed gases.

2. The process according to claim 1, wherein the catalyst carrier in said step (1) is activated alumina, zeolite, activated carbon or diatomite.

3. The process according to claim 1, wherein the impregnating solution in said step (1) has a mass concentration of about 0.25 to 7% and is sodium hydroxide solution, potassium hydroxide solution, ferrous sulfate solution, lead chloride solution, aluminum nitrate solution, sodium carbonate solution, copper acetate solution or lanthanum nitrate solution.

4. The process according to claim 2, wherein said catalyst carrier is activated alumina and wherein the impregnating solution is 0.35 mass % lanthanum nitrate solution.

5. The process according to claim 2, wherein said catalyst carrier is zeolite and wherein the impregnating solution is 0.4 mass % ferrous sulfate solution.

6. The process according to claim 2, wherein said catalyst carrier is activated carbon and wherein the impregnating solution is 0.5 mass % potassium hydroxide solution or sodium hydroxide solution.

7. The process according to claim 2, wherein said catalyst carrier is activated carbon and wherein the impregnating solution is 0.2 mass % copper acetate solution.

8. The process according to claim 2, wherein said catalyst carrier is activated carbon and wherein the impregnating solution is 7 mass % sodium carbonate solution.

9. The process according to claim 2, wherein said catalyst carrier is diatomite and wherein the impregnating solution is 0.55 mass % aluminum nitrate solution.

10. The process according to claim 1, wherein the catalyst in said step (3) when deactivated is activated with hot air for about 4-8 hours, then activated with water vapor for about 2-4 hours, washed with water, then heated to about 95 to 110° C. with stream, and then dried with hot air for about 24-48 hours, resulting in a re-usable activated catalyst.

11. The process according to claim 9, wherein after said diatomite is impregnated with said 0.55 mass % aluminum nitrate solution, said diatomite is further impregnated with 0.25 mass % lead chloride solution.
